(19) United States
(12) Patent Application Publication
(10) Pub. No.: US 2022/0210574 A1
(43) Pub. Date: Jun. 30, 2022

(54) Diaphragm for Waterproof Microspeaker

(71) Applicant: EM-TECH Co., Ltd., Gyeongsangnam-do (KR)

(72) Inventors: Cheon Myeong Kim, Gyeongsangnam-do (KR); Ji Hoon Kim, Gyeongsangnam-do (KR); Jong Soo Yoon, Gyeongsangnam-do (KR); Kil Dong Park, Gyeongsangnam-do (KR); Gi Hun Song, Gyeongsangnam-do (KR); Tae Hyun Park, Gyeongsangnam-do (KR)

(21) Appl. No.: 17/563,715

(22) Filed: Dec. 28, 2021

(30) Foreign Application Priority Data
Dec. 30, 2020 (KR) 10-2020-0188008

(51) Int. Cl. H04R 9/06; H04R 31/00; H04R 7/04; H04R 9/02; H04R 9/04

(52) U.S. Cl. CPC H04R 9/06; H04R 31/003; H04R 7/04; H04R 2499/11; H04R 9/043; H04R 2307/025; H04R 9/027

(57) ABSTRACT

Provided is a diaphragm for a high water pressure waterproof microspeaker. The diaphragm for a waterproof microspeaker includes an annular dome portion formed of an elastic membrane material and having a dome portion protruding upward or downward, an annular outer periphery portion attached to an outer periphery of the dome portion and injection-molded with a material having rigidity, an annular inner periphery portion attached to an inner periphery of the dome portion and injection-molded with a material having rigidity, and a center diaphragm attached to a center of the inner periphery portion, wherein the outer periphery portion and the inner periphery portion are attached to an edge portion by double-shot injection molding.

### TECHNICAL FIELD

The present disclosure relates to a diaphragm for a high water pressure waterproof microspeaker.

### BACKGROUND

Mobile devices are equipped with a micro-speaker to reproduce notification sound or content sound for users. In order to maximize convenience of mobile devices, mobile devices having a water-resistance function have increased, and accordingly, a microspeaker itself installed in mobile devices is required to have a water-resistance function.

FIG. 1 is a view illustrating a waterproof microspeaker according to a related art, having a structure disclosed in Korean Patent Registration No. 10-1889315. A vibrating membrane body includes a rigid top portion 11, a silicone rubber membrane 12, and a plastic support 13 coupled to an edge of the silicone rubber membrane 12. The silicone rubber membrane 12 includes a planar coupling portion 12a positioned at a central position, a connection portion 12b positioned at an edge and injection-coupled to the plastic support 13, and a bent ring portion 12c positioned between the coupling portion 12a and the connection portion 12b. A protrusion or the inwardly recessed bent ring portion 12c is provided at an outer position of the top portion 11 on the silicone rubber membrane 12, an interval between the outer edge of the top portion 11 and the inner edge of the bent ring portion 12c is within a numerical range of 0.002 mm to 0.02 mm, and an adhesive is applied in a gap between the top portion 11 and the bent ring portion 12c.

FIG. 2 is a view illustrating another waterproof microspeaker according to a related art. In the waterproof microspeaker, a magnetic circuit including a yoke 21, a center magnet 22, a side magnet 23, a center top plate 24, and a side top plate 25 is installed in a frame 10. A voice coil 30 is installed in an air gap between the center magnet 22 and the side magnet 23, and when a current is applied to the voice coil 30, the voice coil vibrates up and down by mutual electromagnetic force with the magnetic circuit. An upper end of the voice coil 30 is attached to a lower surface of a center diaphragm 50 and a side diaphragm 41 to vibrate the center diaphragm 50 and the side diaphragm 41.

In order to seal between an inner wall of a device A in which the microspeaker is installed and the microspeaker, the side diaphragm 41 has a waterproof structure.

The side diaphragm 41 is attached to a support body 42, and a waterproof ring 43 which protrudes is installed outside the support body 42. An adhesive having adhesive force is applied to the side diaphragm 41 and the support body by heat and pressure. After the side diaphragm 41 is seated on the support 42 during an assembly process, heat and pressure may be applied to attach the support body 42 and the side diaphragm 41 to each other.

The waterproof ring 43 is formed by injection molding with liquid silicone rubber or is formed by a cured in place gasket (CIPG) method.

According to the related art, since the shape of the diaphragm (silicone rubber membrane) is formed and attached by applying a bond to the frame or diaphragm, a waterproof defect rate is affected by the applied amount of bond, an application location, and pressure at the time of attachment. In addition, since acoustic parts are assembled using a waterproof tape during assembling with electronic devices, there is a disadvantage in that the waterproof defect rate is affected according to the amount of compression and foreign matter management of the waterproof tape.

### SUMMARY

An aspect of the present disclosure provides a waterproof diaphragm having an improved waterproof function by coupling parts requiring waterproofing through double-shot injection molding.

In an aspect, a diaphragm for a waterproof microspeaker includes: an annular dome portion formed of an elastic membrane material and having a dome portion protruding upward or downward; an annular outer periphery portion attached to an outer periphery of the dome portion and injection-molded with a material having rigidity; an annular inner periphery portion attached to an inner periphery of the dome portion and injection-molded with a material having rigidity; and a center diaphragm attached to a center of the inner periphery portion, wherein the outer periphery portion and the inner periphery portion are attached to an edge portion by double-shot injection molding.

The center diaphragm may be formed of a material different from materials of the outer periphery portion and the inner periphery portion.

The outer periphery portion may be formed of a metal material.

The center diaphragm may be attached to an upper surface or a lower surface of the inner periphery portion.

A width of an attachment portion of the inner periphery portion and the center diaphragm may be 0.3 mm or greater.

A voice coil may be attached to the inner periphery portion, a step may be provided between a voice coil attachment portion and an attachment portion of the center diaphragm, and a width of the voice coil attachment portion may be equal to or greater than a thickness of the voice coil.

A voice coil may be attached to the center diaphragm.

The dome portion may include one or more dome portions protruding upward or downward.

### BRIEF DESCRIPTION OF THE DRAWINGS

FIG. 1 is a view illustrating a waterproof microspeaker according to the related art;

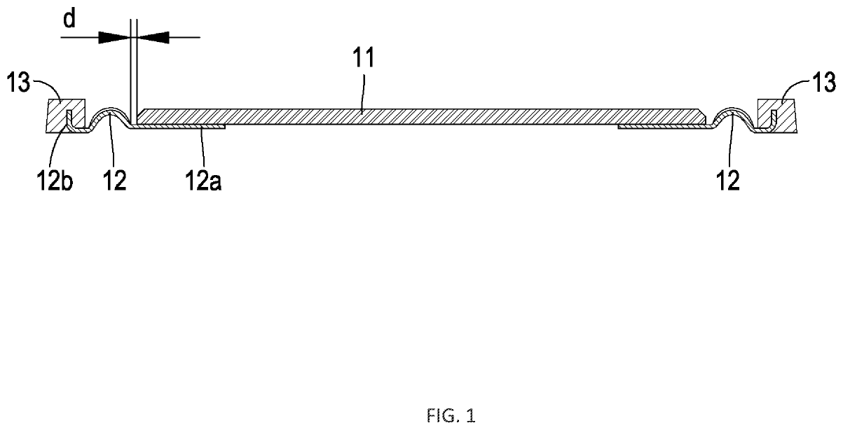

FIG. 2 is a view illustrating another waterproof microspeaker according to the related art;

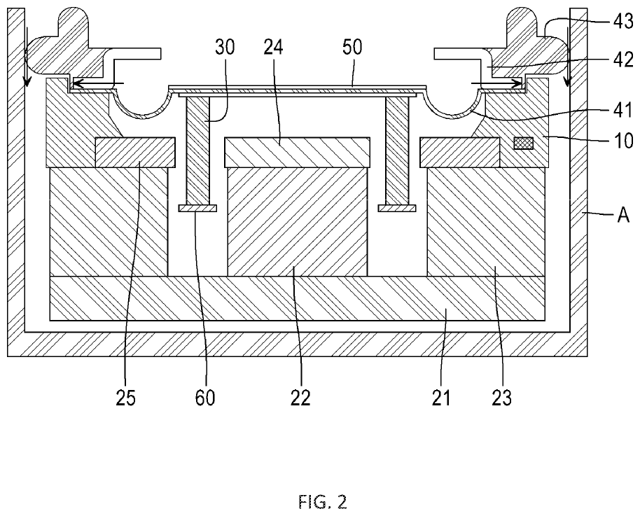

FIG. 3 is a view illustrating a diaphragm for a waterproof microspeaker according to a first embodiment of the present disclosure;

FIG. 4 is a cross-sectional view of a diaphragm for a waterproof microspeaker according to the first embodiment of the present disclosure;

FIG. 5 is a view illustrating a diaphragm for a waterproof microspeaker according to a second embodiment of the present disclosure;

FIG. 6 is a view illustrating a diaphragm for a waterproof microspeaker according to a third embodiment of the present disclosure; and

FIG. 7 is a view illustrating a diaphragm for a waterproof microspeaker according to a fourth embodiment of the present disclosure.

### DETAILED DESCRIPTION

Hereinafter, the present disclosure is described in more detail with reference to the accompanying drawings.

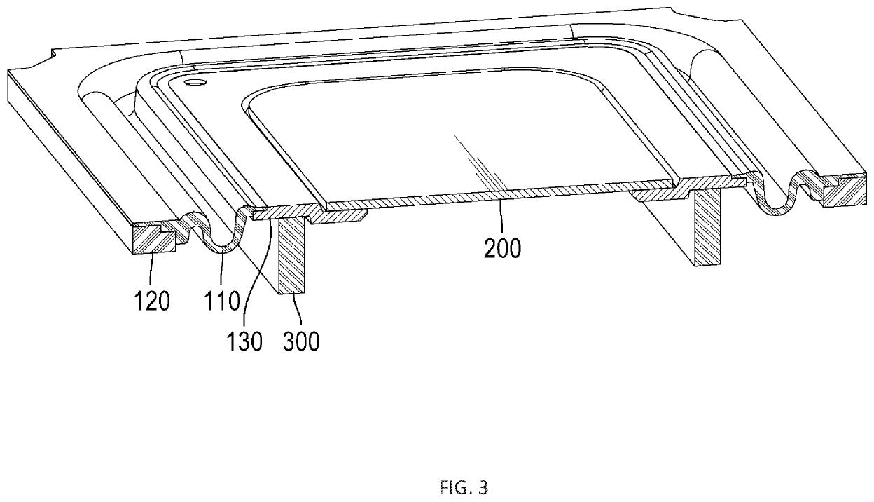

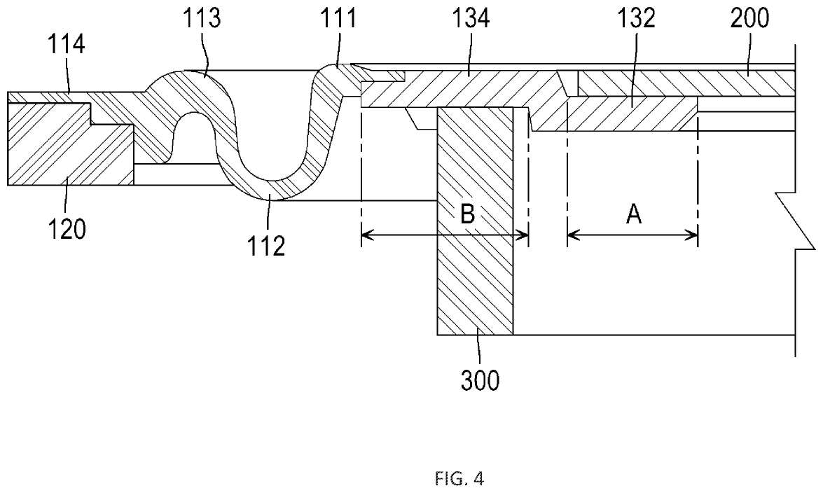

FIG. 3 is a view illustrating a diaphragm for a waterproof microspeaker according to a first embodiment of the present disclosure, and FIG. 4 is a cross- sectional view of a diaphragm for a waterproof microspeaker according to the first embodiment of the present disclosure.

In a diaphragm for a waterproof microspeaker according to the first embodiment of the present disclosure, a center diaphragm 200 is attached to the center of an edge diaphragm 100 having a ring shape overall as a central portion thereof is proliferated.

The edge diaphragm 100 includes an annular dome portion formed of an elastic membrane material and having a dome portion protruding upward or downward, an annular outer periphery portion 120 attached to an outer periphery of the dome portion 110 and injection-molded with a material having rigidity, and an annular inner periphery portion 130 attached to an inner periphery of the dome portion 110 and injection-molded with a material having rigidity.

The dome portion 110 is formed of a material having elasticity and has one or more annular domes to perform a damping function to guide vibration to ensure smooth vibrations when a voice coil 300, the inner periphery portion 130 to which the voice coil 300 is attached, and the center diaphragm 200 vibrate up and down.

The dome portion 110 is preferably injection-molded with liquid silicone rubber. Here, by integrally forming the outer periphery portion 120 and the inner periphery portion 130 by double-shot injection molding, water may be prevented from being introduced between the dome portion 110 and an attached portion.

The outer periphery portion 120 and the inner periphery portion 130 are generally formed of a plastic injection material, and the type of plastic used as the material may vary according to requirements such as strength and density.

Since the inner periphery portion 130 is required to be insulated from the voice coil 300 is required and a weight of a vibrating portion is required to be reduced to improve a sound output, the material of the inner periphery portion 130 is preferably a plastic material having a relatively light density. Meanwhile, the outer periphery portion 120 fixed to the frame (not shown) may be formed of a metal material because insulation is unnecessary and a weight thereof does not affect a vibration system.

Meanwhile, the center diaphragm 200 is separately manufactured with a material having relatively high rigidity and is attached to the edge diaphragm 100. The center diaphragm 200 may be formed of the same material as the that of the outer periphery portion 120 and the inner periphery portion 130 or formed of a different material. The center diaphragm 200 may be attached to an upper side of the inner periphery portion 130 or may be attached to a lower side thereof, and in the first embodiment of the present disclosure, the center diaphragm is attached to an upper side of the inner periphery portion 130.

Referring to FIG. 4, the center diaphragm 200 is attached to the upper side of the inner periphery portion, and the voice coil 300 is attached to the lower side of the inner periphery portion. Here, a step is formed between a center diaphragm attachment portion 132 to which the center diaphragm 200 is attached and a voice coil attachment portion 134 to which the voice coil 300 is attached, to guide an attachment position of the center diaphragm 200 and the voice coil 300.

Here, a width A of an attachment surface to which the center diaphragm attachment portion 132 and the center diaphragm 200 are actually attached may be 0.3 mm or greater. The width A of the attachment surface should be 0.3 mm or greater to satisfy waterproof performance of IPX 8.

Meanwhile, a width B of the voice coil attachment portion 134 has nothing to do with the waterproof performance, and may be greater than a thickness of the voice coil 300 so that the voice coil 300 may be stably attached.

In addition, the dome portion 110 includes an inner periphery 111 attached to the inner periphery portion 130, an outer periphery 114 attached to the outer periphery portion 120, and one or more domes 112 and 113 located between the inner periphery 111 and the outer periphery 114 and protruding upward or downward. In the first embodiment of the present disclosure, the dome portion includes a first dome 112 positioned on the inside and protruding downward and a second dome 113 positioned on the outside and protruding upward are provided.

When two or more domes 112 and 113 are formed, even if a protrusion height of the individual domes 112 and 113 is low, sufficient damping force may be obtained, which helps in slimming the waterproof microspeaker.

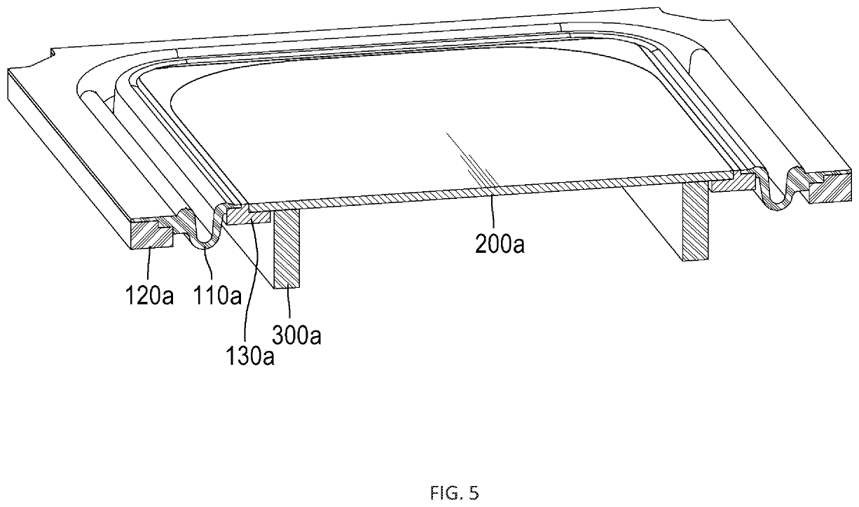

FIG. 5 is a view illustrating a diaphragm for a waterproof microspeaker according to a second embodiment of the present disclosure.

The diaphragm for a waterproof microspeaker according to the second embodiment of the present disclosure is the same as the diaphragm for a waterproof microspeaker according to the first embodiment of the present disclosure, except that a voice coil 300a is attached to a center diaphragm 200a, rather than to an inner periphery portion 130a. Accordingly, unlike the first embodiment, the inner periphery portion 130a does not have a separate step for attaching the voice coil 300a and has only a seating end for attaching the center diaphragm 200a.

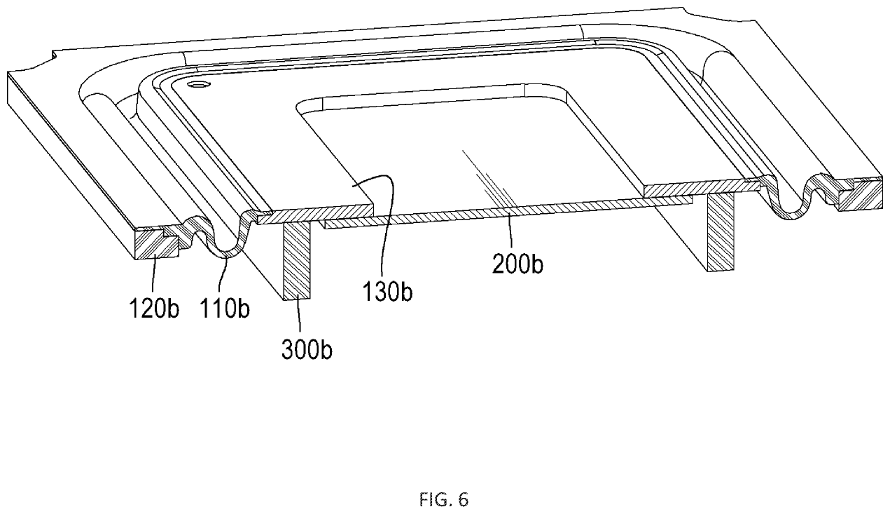

FIG. 6 is a view illustrating a diaphragm for a waterproof microspeaker according to a third embodiment of the present disclosure.

The diaphragm for a waterproof microspeaker according to the third embodiment of the present disclosure is different from the first embodiment in that a center diaphragm 200b is attached to a lower side of an inner periphery portion 130b.

Since both the center diaphragm 200b and a voice coil 300b are attached to a lower surface of the inner periphery portion 130b, the inner periphery portion 130b does not have a step difference, unlike the first embodiment.

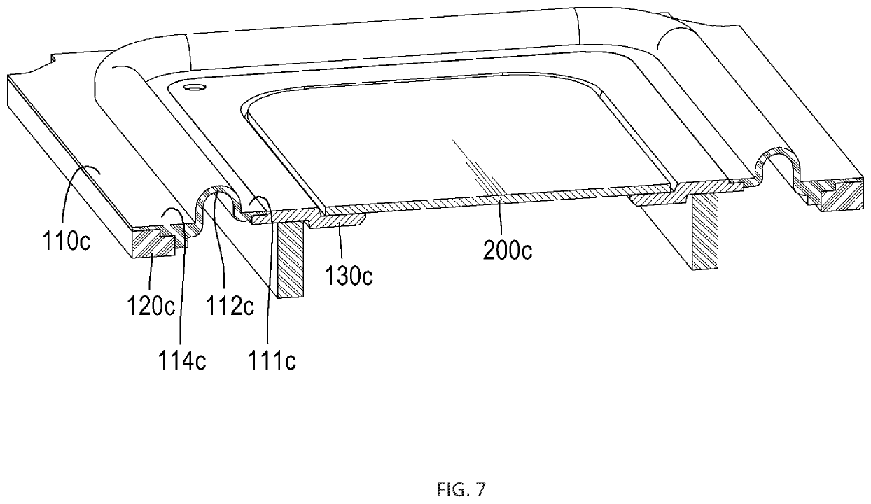

FIG. 7 is a view illustrating a diaphragm for a waterproof microspeaker according to a fourth embodiment of the present disclosure.

The diaphragm for a waterproof microspeaker according to the fourth embodiment of the present disclosure is different from the first embodiment in that a dome portion 110c includes only one dome 112c protruding upward.

The dome 112c provided in the dome portion 110c may protrude upward or downward as necessary, and in the case of the fourth embodiment of the present disclosure in which the dome 112c protrudes upward, a thickness of an overall microspeaker unit may be slightly increased. However, there is an advantage that there is no interference in a lower portion of the diaphragm, so that a size of a magnetic field may be increased or a separate suspension may be attached.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A diaphragm for a waterproof microspeaker, the diaphragm comprising:
an annular dome portion formed of an elastic membrane material and having a dome portion protruding upward or downward;
an annular outer periphery portion attached to an outer periphery of the dome portion and injection-molded with a material having rigidity;
an annular inner periphery portion attached to an inner periphery of the dome portion and injection-molded with a material having rigidity; and
a center diaphragm attached to a center of the inner periphery portion,
wherein the outer periphery portion and the inner periphery portion are attached to an edge portion by double-shot injection molding.

2. The diaphragm of claim 1, wherein the center diaphragm is formed of a material different from the materials of the outer periphery portion and the inner periphery portion.

3. The diaphragm of claim 1, wherein the outer periphery portion is formed of a metal material.

4. The diaphragm of claim 1, wherein the center diaphragm is attached to an upper surface or a lower surface of the inner periphery portion.

5. The diaphragm of claim 1, wherein a width of an attachment portion of the inner periphery portion and the center diaphragm is 0.3 mm or greater.

6. The diaphragm of claim 1, further comprising a voice coil attached to the inner periphery portion, wherein a step is provided between a voice coil attachment portion and an attachment portion of the center diaphragm, and wherein a width of the voice coil attachment portion is equal to or greater than a thickness of the voice coil.

7. The diaphragm of claim 1, further comprising a voice coil attached to the center diaphragm.

8. The diaphragm of claim 1, wherein the dome portion includes one or more dome portions protruding upward or downward.
